(19) United States
(12) Patent Application Publication
(10) Pub. No.: US 2011/0138275 A1
(43) Pub. Date: Jun. 9, 2011

(54) Method for selecting functional icons on touch screen

(76) Inventor: Jo Hai Yu, Taipei City (TW)

(21) Appl. No.: 12/800,351

(22) Filed: May 12, 2010

(30) Foreign Application Priority Data
Dec. 9, 2009 (TW) 098142004

(51) Int. Cl. G06F 3/048

(52) U.S. Cl. 715/702; 715/835

(57) ABSTRACT

A method for selecting functional icons is provided for use with an electronic device having a touch screen. A plurality of functional icons are shown on the touch screen, in which each functional icon represents an executable function of the electronic device. The method comprises the steps of: when the touch screen is touched, selecting a functional icon corresponding to the touched position, and showing an enlarged image corresponding to that selected functional icon; if the touched position is moved, selecting a new functional icon according to the vector of movement of the touched position, and showing an enlarged image corresponding to the newly selected functional icon; and if the touched position is relieved, activating the executable function represented by the functional icon corresponding to the enlarged image shown on the touch screen.

### BACKGROUND OF INVENTION

1. Field of the Invention

The present invention relates to a method for selecting functional icons on a touch screen and, more particularly, to a method for controlling the selection of functional icons on a touch screen of a portable electronic device.

2. Description of the Prior Art

The touch panel, or touch screen, features visualized intuitive input as well as easy and convenient operation. Hence, in recent years, touch screens have become a standard component of many portable electronic devices that emphasize compactness and therefore do not require the installation of keyboards.

However, as these portable electronic devices are made ever slimmer and lighter for higher portability, the touch screens thereof are restricted in dimension. Taking a smart phone with a touch screen for example, the size of the touch screen is usually between 2 and 3.5 inches, so the functional icons shown on the screen are rather small. Therefore, when the touch screen is operated by the finger of an adult, it is very likely that a wrong functional icon is selected, or more than two functional icons are selected at the same time, thus leading to input errors. Although some manufacturers provide touch pens, or styluses, for pinpointing locations on a touch screen, most consumers demand a sense of “activeness” in their portable electronic devices; in other words, the desired operation must be completed conveniently and rapidly. The stylus, however, is too short and too thin to handle and may easily drop to the ground or get lost. Consequently, the stylus may contribute adversely to the convenience of a touch screen and is not the best solution.

In order to reduce input errors attributable to small touch screens, related manufacturers have developed several touch-screen input methods. For example, according to one such conventional technique, the touch screen will display a full-size keyboard with small input keys representing letters from a to z and other symbols, wherein the keys are divided into five adjacent key groups. When a user touches one or more keys of a certain key group, all the keys in that key group are enlarged and displayed where they are. The user has to press one of the enlarged keys in the key group, and the letter or symbol represented by the selected key will be displayed on the touch screen as a confirmation of the selection. However, this technique still has its drawbacks. First of all, the user must touch the touch screen at least twice to input one letter or symbol. Moreover, if two adjacent key groups are accidentally touched at the same time, the enlarged keys of the two key groups will cover nearby keys, making it difficult to select from the covered keys. According to another conventional technique, if two or more functional icons on the touch screen are erroneously touched at the same time, the two or more functional icons touched will be displayed where they are in an enlarged format. The user has to re-select from the two or more enlarged icons to complete the selection. As a result, the drawbacks of this technique are similar to those of the previously described: the user must click twice on the touch screen to make a selection, and the enlarged icons will cover, and hence hinder the selection of, adjacent icons.

### SUMMARY OF INVENTION

The present invention aims to provide a functional icon selection method to be implemented on a touch screen, wherein the method allows a user to complete functional icon selection with only one touch, regardless of a wrong selection of adjacent functional icons in an initial attempt. Furthermore, the functional icon selected will be displayed without covering adjacent icons. Thus, the functional icon selection method of the present invention greatly enhances the operational convenience of the touch screen.

In order to achieve the aforementioned objective, the present invention discloses a method for selecting functional icons on a touch screen, which is applicable to an electronic device with the touch screen. The method comprising steps of:

starting the method for selecting functional icons;

displaying a plurality of functional icons on the touch screen, wherein each said functional icon represents an executable function;

detecting a touched state of the touch screen; and if the touch screen is touched at a position thereof, selecting from the plurality of functional icons a said functional icon that corresponds to the touched position, and displaying on the touch screen an enlarged image corresponding to the selected functional icon; and

continuing detecting the touched state of the touch screen; if the touched position is displaced to a new location, selecting another said functional icon according to a vector of displacement of the touched position, and displaying on the touch screen an enlarged image that corresponds to the newly selected functional icon; and if the touched state is released, activating a said executable function represented by the newly selected functional icon corresponding to the enlarged image displayed.

In a preferred embodiment, each said enlarged image is larger than the corresponding functional icon.

In a preferred embodiment, each said enlarged image is one of: (i) a proportionally enlarged image of the selected functional icon, (ii) an image larger than the selected functional icon and corresponding to the executable function represented by the selected functional icon, (iii) a motion picture corresponding to the executable function represented by the selected functional icon, and (iv) an image including explanatory text corresponding to the executable function represented by the selected functional icon.

In a preferred embodiment, the method further comprises a step that issues a sound by the electronic device to signal that a said functional icon is selected, while a corresponding said enlarged image is displayed.

In a preferred embodiment, the selecting from the plurality of functional icons a said functional icon that corresponds to the touched position comprises selecting a said functional icon nearest to the touched position.

In a preferred embodiment, the touch screen is divided into a plurality of sensing regions extending parallel from and corresponding to the plurality of functional icons respectively, such that when the touch screen is touched, the touch screen senses a touched region, and the selecting from the plurality of functional icons a said functional icon that corresponds to the touch position comprises selecting a said functional icon that corresponds to a said sensing region having a largest overlapping area with the touched region.

In a preferred embodiment, the touch screen comprises a function window in which the plurality of functional icons are arranged, and a main display window in which a said enlarged image is displayed, such that the enlarged image displayed in the main display window does not cover any said functional icon in the function window.

### BRIEF DESCRIPTION OF THE DRAWINGS

The present invention as well as a preferred mode of use, further objectives and advantages thereof will best be understood by reference to the following detailed description of illustrative embodiments when read in conjunction with the accompanying drawings, wherein:

FIG. 1 is a schematic view of an embodiment of a portable electronic device suitable for implementing a method for selecting functional icons on a touch screen according to the present invention;

FIG. 2 is a flowchart of a method for selecting functional icons on a touch screen according to a first embodiment of the present invention;

FIG. 3 is a schematic view of a first operational state of the portable electronic device shown in FIG. 1 when implementing the method of the present invention;

FIG. 4 is a schematic view of a second operational state of the portable electronic device shown in FIG. 1 when implementing the method of the present invention;

FIG. 5 is a flowchart of a method for selecting functional icons on a touch screen according to a second embodiment of the present invention; and

FIG. 6 is a schematic view of a third operational state of the portable electronic device shown in FIG. 1 when implementing the method of the present invention.

### DETAILED DESCRIPTION OF THE PREFERRED EMBODIMENT

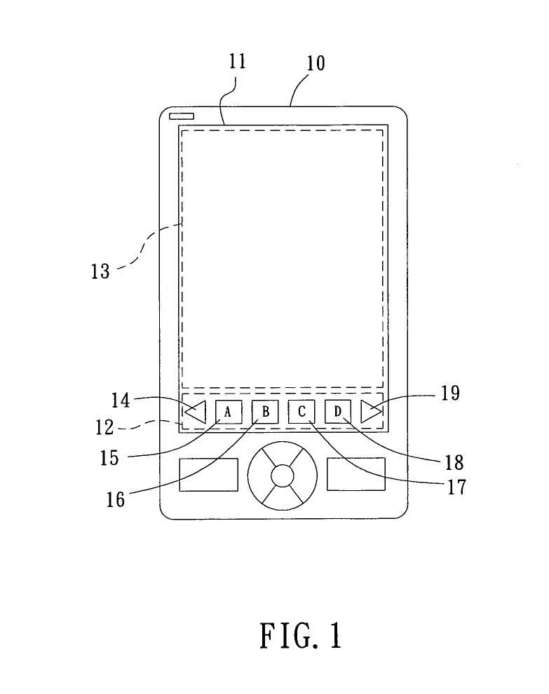

FIG. 1 shows an embodiment of a portable electronic device suitable for use with a method for selecting functional icons on a touch screen according to the present invention. The method of the present invention is applicable mainly to a portable electronic device 10 with a touch screen 11. The portable electronic device 10 may be, but is not limited to, a smart phone, a personal digital assistant, a digital photo frame, a digital still camera, a digital video camera, a satellite navigation device, an e-book, or a laptop computer. The touch screen 11 is a touch screen configured for either press-type input or sensor-type input, such as, but not limited to, a resistive touch screen, which generates an electric voltage when pressed by a finger or stylus; a capacitive touch screen, which works on the absorption of tiny electric current by a finger; and a wave-based touch screen, which uses acoustic waves or invisible light to cover the entire exposed surface and thereby detect a touched position thereon. As the portable electronic device 10 and the touch screen 11 are both available from the prior art and do not constitute a technical feature of the present invention, they will not be further described hereinafter.

The display area of the touch screen 11 is generally divided into a function window 12 and a main display window 13. The function window 12 is usually a strip-like area extending along a side of the touch screen 11, such as, but not limited to, a bottom side of the touch screen 11, as shown in FIG. 1. A plurality of functional icons 14-19 are displayed and arranged in the function window 12, wherein each functional icon 14-19 represents an executable function, respectively. In other words, when any one of the functional icons 14-19 is touched by a finger, a stylus, or any other objects, the executable function represented by the touched functional icon will be triggered and executed. In the present embodiment, the executable functions include, but are not limited to, linking to the Internet, dialing a telephone number, activating a camera function, opening a file or a database, sending and receiving a text message, enabling stocks or securities trading, activating a satellite positioning function, activating an input method, enabling a direction control key, and activating a scroll function. In the embodiment shown in FIG. 1, functional icons A, B, C, and D represent different executable functions respectively, and the other two functional icons 14, 19 located at the left and right ends represent “scroll left” and “scroll right” functions respectively to allow more functional icons to be displayed. In this embodiment, the main display window 13 occupies the majority of the area of the touch screen 11 and does not overlap with the function window 12; however, the main display window 13 may overlap with the function window 12 in a different embodiment.

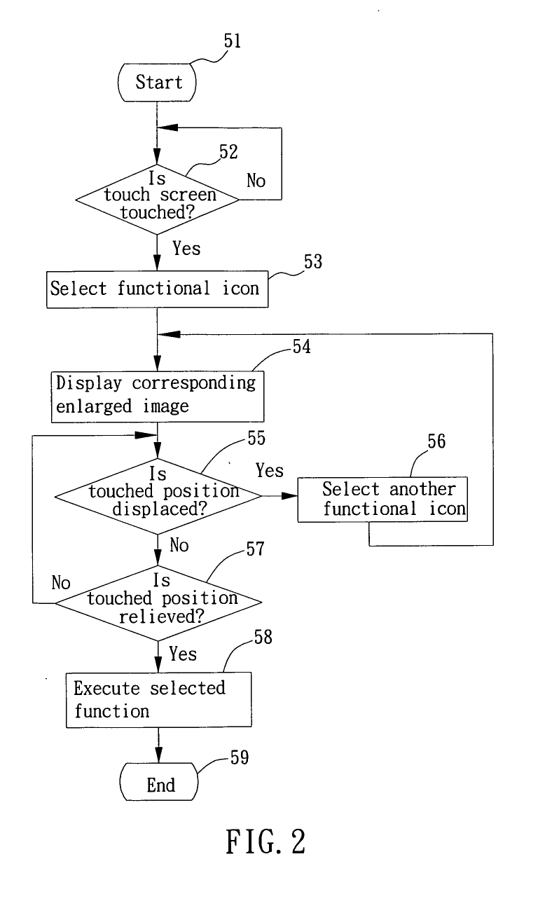

Please refer to FIG. 2 for a flowchart of the method for selecting functional icons on a touch screen according to a first embodiment of the present invention, wherein the method includes the following steps.

At Step 51, the method for selecting functional icons according to the present invention is started, and, as shown in FIG. 1, a plurality of functional icons 14-19 are displayed on the touch screen 11, wherein each of the functional icons 14-19 represents an executable function.

At Step 52, it is detected whether or not the touch screen 11 is touched, i.e., in a touched state. If not, it will be re-detected at regular intervals whether or not the touch screen 11 is in the touched state.

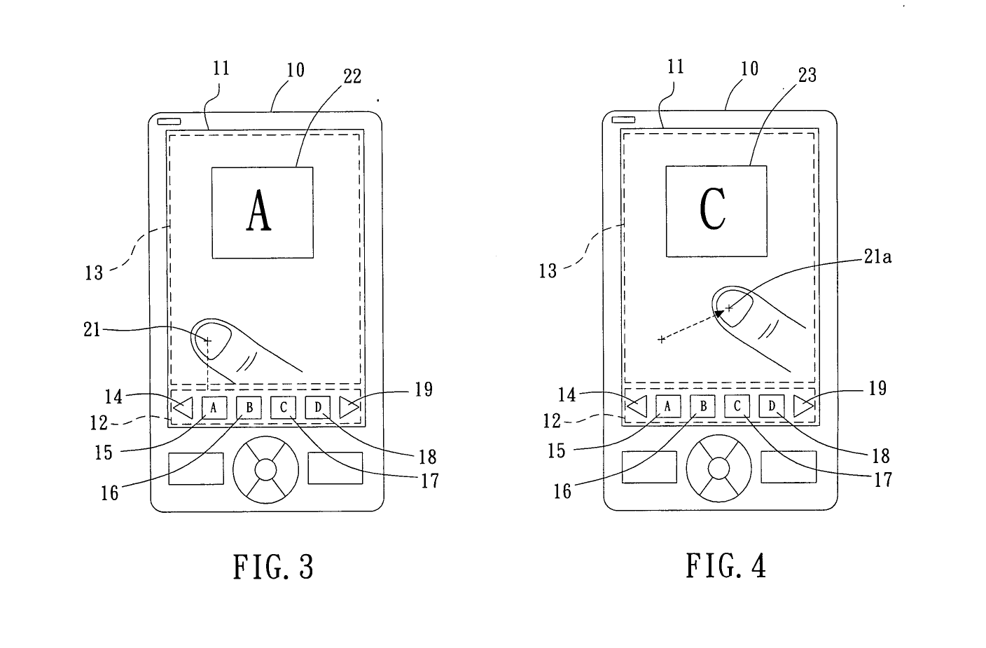

At Step 53, a functional icon is selected. As shown in FIG. 3, when it is detected at Step 52 that a certain position 21 on the touch screen 11 is touched by a finger, a stylus, or other objects, the method for selecting functional icons according to the present invention automatically selects from the plural functional icons 14-19 a functional icon that corresponds to the touched position 21 (e.g., the functional icon 15). Meanwhile, an enlarged image 22 corresponding to the selected functional icon 15 is displayed on the touch-screen 11 at Step 54. In the present embodiment, the enlarged image 22 is larger than the functional icon 15 so as to be clearly and easily identified by the user. However, it is also feasible to display an image of the same size as the selected functional icon, but in this case the image may not be identified as easily. Also, the content of the enlarged image 22 may be, but is not limited to, one of the following: (i) a proportionally enlarged image of the functional icon 15; (ii) an image which corresponds to the executable function represented by the functional icon 15, and is larger than the functional icon 15, wherein the image may differ from the selected functional icon; (iii) a motion picture (with animated images and sound) corresponding to the executable function represented by the functional icon 15; and (iv) an image containing explanatory text corresponding to the executable function represented by the functional icon 15, wherein the image includes the explanatory text in addition to a graphic illustration. While the enlarged image 22 is displayed, the portable electronic device 10 may also issue a sound, signaling that a certain functional icon has been selected. In this embodiment, the principle of selecting from the plural functional icons 14-19 the functional icon 15 that corresponds to the touched position 21 is to select the functional icon nearest to the touched position 21. Taking the embodiment shown in FIG. 3 for example, the selected functional icon 15 is the functional icon corresponding vertically to the touched position 21.

At Step 55, it is detected whether or not the touched position is displaced. The detection for the touched state of the touch screen 11 continues. If the touched state persists, and moreover, the touched position 21 is displaced to a new location 21a (as shown in FIG. 4), another functional icon 17 is selected at Step 56 according to the vector of displacement (i.e., the direction and distance of displacement) of the touched position. Then, the process returns to Step 54 to display on the touch screen 11 an enlarged image 23 that corresponds to the newly selected functional icon 17. In this embodiment, the newly selected functional icon 17 resulting from the new location 21a is selected by first finding out the displacement vector from the original touched position 21 to the new location 21a, and then carrying out a scroll left or scroll right function so as to switch to other functional icons. Therefore, the newly selected functional icon is not necessarily the functional icon nearest to the new location 21a after the displacement. However, in another embodiment, the newly selected functional icon 17 resulting from the new location 21a after the displacement may also be determined in the same way as at Steps 53; in other words, the newly selected functional icon 17 is the one nearest to the new location 21a after the displacement. In either case, the user can switch and select different functional icons by displacing the touched position.

At Step 57, it is detected whether or not the touched position is relieved. The detection for the touched state of the touch screen 11 continues. If the touched state is released, the executable function represented by the functional icon 17 corresponding to the enlarge image 23 is activated at Step 58, followed by Step 59, which ends the method for selecting functional icons according to the present invention. If the touched state persists, the process goes back to Step 55 to continuously detect whether or not the touched position is displaced.

From the above description, it is obvious that the method for selecting functional icons according to the present invention only requires one touch to complete the selection of a desired functional icon from the function menu, as well as the activation of the executable function represented by the selected functional icon. Even if the touched position is incorrect in an initial attempt, the touched position can be shifted so as to select the desired functional icon. Once the correct functional icon is selected, the executable function represented by the selected functional icon will be executed upon release of the touch. In contrast to the conventional methods that typically require at least two touches, the functional icon selection method according to the present invention is obviously more convenient and easier from the user's viewpoint. In addition, according to the functional icon selection method of the present invention, an enlarged image corresponding to the functional icon selected from the function window is displayed in the main display window. Not only is the displayed image larger than the functional icon to facilitate identification, but also the enlarged image and the functional icons are shown in separate regions of the touch screen to avoid interference with each other. Hence, the method proposed in the present invention has overcome the drawbacks of the prior art.

In the embodiment to be described below, most of the components and techniques are similar to those in the aforementioned embodiments. Therefore, the sake of brevity, the same components and steps are given the same reference numerals and names and will not be described repeatedly.

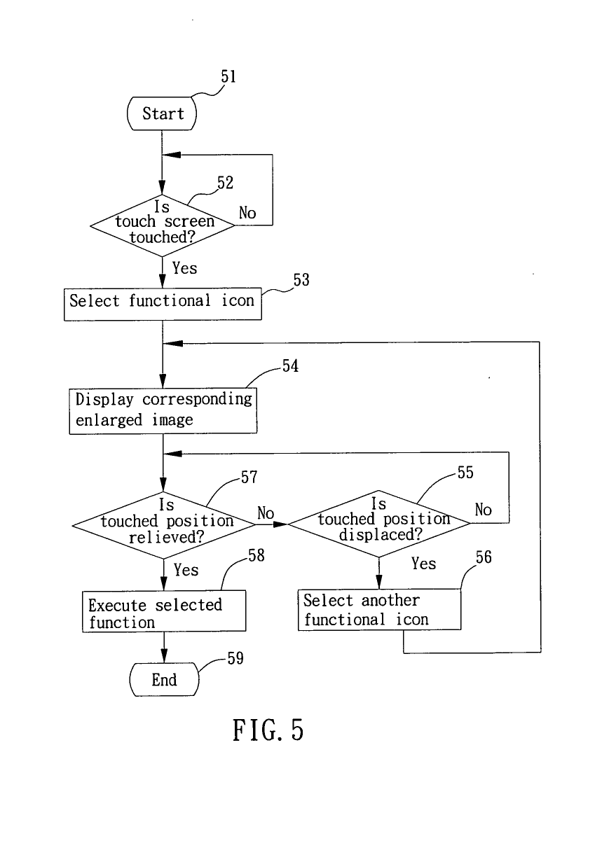

FIG. 5 is a flowchart of the method for selecting functional icons on a touch screen according to a second embodiment of the present invention. This embodiment is different from the first embodiment shown in FIG. 2 in that Step 54, at which the touch screen displays an enlarged image corresponding to the selected functional icon, is immediately followed by Step 57, at which it is detected whether or not the touched position is relieved. If not, Step 55 is carried out to check whether or not the touched position is displaced. This procedure achieves the same effect as the first embodiment. As the remaining part of the second embodiment is identical to that of the first embodiment, the same content is not repeated herein.

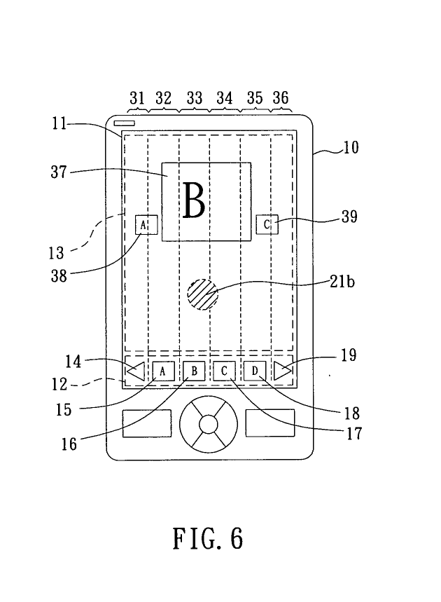

Please refer to FIG. 6 for another operational state of the portable electronic device shown in FIG. 1 when implementing the method of the present invention. Oftentimes, when the touch screen 11 is touched, it is not a single point but a touched region 21b with a variable area that is actually touched, wherein the touched region 21b may span the widths of two or more of the functional icons 14-19. To determine the functional icon corresponding to such a touched region 21b, the display area of the touch screen according to the present invention is divided into a plurality of sensing regions 31-36 that extend parallel from and correspond to the functional icons 14-19 respectively. When the touch screen 11 is touched, and the touched region 21b sensed by the touch screen 11 crosses two or more sensing regions (e.g., the sensing regions 33, 34), the method of the present invention calculates the overlapping areas between the touched region 21b and the corresponding sensing regions (e.g., the sensing regions 33, 34), determines which sensing region has the largest overlapping area with the touched region 21b (e.g., the sensing region 33), and then selects the functional icon corresponding to the sensing region that has the largest overlapping area with the touched region 21b (e.g., the functional icon 16). In another embodiment, the center point of the touched region 21b is calculated and viewed as the touched position 21 shown in FIG. 3, before Step 53 of FIG. 2 is executed to select the corresponding functional icon, as with reference to FIG. 3. Furthermore in the embodiment shown in FIG. 6, when an enlarged image 37 corresponding to the selected functional icon 16 is displayed in the main display window 13, two small icons 38, 39, which correspond respectively to the functional icons 15, 17 that flank the functional icon 16, are displayed on two sides of the enlarged image 37 as a reference for the user during operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for selecting functional icons on a touch screen, applicable to an electronic device with the touch screen, the method comprising steps of:
starting the method for selecting functional icons;
displaying a plurality of functional icons on the touch screen, wherein each said functional icon represents an executable function;
detecting a touched state of the touch screen; and if the touch screen is touched at a position thereof, selecting from the plurality of functional icons a said functional icon that corresponds to the touched position, and displaying on the touch screen an enlarged image corresponding to the selected functional icon; and
continuing detecting the touched state of the touch screen; if the touched position is displaced to a new location, selecting another said functional icon according to a vector of displacement of the touched position, and displaying on the touch screen an enlarged image that corresponds to the newly selected functional icon; and if the touched state is released, activating a said executable function represented by the newly selected functional icon corresponding to the enlarged image displayed.

2. The method of claim 1, wherein each said enlarged image is larger than the corresponding functional icon.

3. The method of claim 1, wherein each said enlarged image is one of: (i) a proportionally enlarged image of the selected functional icon, (ii) an image larger than the selected functional icon and corresponding to the executable function represented by the selected functional icon, (iii) a motion picture corresponding to the executable function represented by the selected functional icon, and (iv) an image including explanatory text corresponding to the executable function represented by the selected functional icon.

4. The method of claim 1, further comprising issuing a sound by the electronic device to signal that a said functional icon is selected, while a corresponding said enlarged image is displayed.

5. The method of claim 1, wherein the selecting from the plurality of functional icons a said functional icon that corresponds to the touched position comprises selecting a said functional icon nearest to the touched position.

6. The method of claim 1, wherein the touch screen is divided into a plurality of sensing regions extending parallel from and corresponding to the plurality of functional icons respectively, such that when the touch screen is touched, the touch screen senses a touched region, and the selecting from the plurality of functional icons a said functional icon that corresponds to the touch position comprises selecting a said functional icon that corresponds to a said sensing region having a largest overlapping area with the touched region.

7. The method of claim 1, wherein the touch screen comprises a function window in which the plurality of functional icons are arranged, and a main display window in which a said enlarged image is displayed, such that the enlarged image displayed in the main display window does not cover any said functional icon in the function window.

8. A method for selecting functional icons on a touch screen, applicable to an electronic device with the touch screen, wherein the touch screen is divided into a function window and a main display window and is configured to display a plurality of functional icons in the function window, each said functional icon representing an executable function, the method comprising steps of:
when the touch screen is touched at a position thereof, selecting from the plurality of functional icons a said functional icon that corresponds to the touched position, and displaying in the main display window an image corresponding to the selected functional icon;
if the touched position is relieved, activating a said executable function represented by the functional icon corresponding to the image displayed in the main display window; and
if the touched position is not relieved but is displaced to a new location, selecting another said functional icon according to a vector of displacement of the touched position, and displaying in the main display window an image corresponding to the newly selected functional icon,
wherein the image displayed in the main display window does not cover any said functional icon in the function window.

9. The method of claim 8, wherein said image displayed in the main display window is larger than the corresponding functional icon.

10. The method of claim 8, wherein said image displayed in the main display window is one of: (i) a proportionally enlarged image of the selected functional icon, (ii) an image larger than the selected functional icon and corresponding to the executable function represented by the selected functional icon, (iii) a motion picture corresponding to the executable function represented by the selected functional icon, and (iv) an image including explanatory text corresponding to the executable function represented by the selected functional icon.

11. The method of claim 8, further comprising issuing a sound by the electronic device to signal that a said functional icon is selected, while a corresponding said image is displayed.

12. The method of claim 8, wherein the selecting from the plurality of functional icons a said functional icon that corresponds to the touched position comprises selecting a said functional icon nearest to the touched position.

13. The method of claim 8, wherein the touch screen is divided into a plurality of sensing regions extending parallel from and corresponding to the plurality of functional icons respectively, such that when the touch screen is touched, the touch screen senses a touched region, and the selecting from the plurality of functional icons a said functional icon that corresponds to the touch position comprises selecting a said functional icon that corresponds to a said sensing region having a largest overlapping area with the touched region.
